(19) United States
(12) Patent Application Publication
(10) Pub. No.: US 2006/0187335 A1
(43) Pub. Date: Aug. 24, 2006

(54) Image pickup apparatus

(75) Inventors: Tetsuya Ohtsuka, Asaka (JP); Hitoshi Miyano, Saitama (JP)

Correspondence Address: SUGHRUE MION, PLLC, 2100 PENNSYLVANIA AVENUE, N.W., SUITE 800, WASHINGTON, DC, 20037, US

(73) Assignees: FUJI PHOTO FILM CO., LTD.; FUJINON CORPORATION

(21) Appl. No.: 11/357,126

(22) Filed: Feb. 21, 2006

(30) Foreign Application Priority Data
Feb. 23, 2005 (JP) 2005-047354

(51) Int. Cl. H04N 5/238

(52) U.S. Cl. 348/369

(57) ABSTRACT

A small image-pickup apparatus generating image signals representing subject light based on the subject light coming through an image-taking optical system, has: an image-pickup device generating image signals representing a subject image formed by the subject light focused on a surface thereof; a light reflecting mechanism leading the subject light to the image-pickup device as the subject light coming through the image-taking optical system is reflected in sequence by multiple reflector sections placed apart from each other; a rotation sensor sensing rotation of the image-pickup apparatus in a place along a surface of the image-pickup device; and a rotating mechanism reducing displacement of the subject image resulting from the rotation sensed by the rotation sensor, by rotating at least one of the multiple reflector sections around an axis along an optical path among the multiple reflector sections, whereby preventing camera shake.

### BACKGROUND OF THE INVENTION

1. Field of the Invention

The present invention relates to an image pickup apparatus which forms subject light and generates image signals to represent subject light.

2. Description of the Related Art

Image pickup apparatus which shoot subjects and generate image data have been downsized and it has become common practice to incorporate such an image pickup apparatus in small equipment such as cell phones and PDAs (Personal Digital Assistants). By incorporating an image pickup apparatus in small equipment carried on a routine basis, it is possible to photograph readily any time without the trouble of carrying a digital camera or video camera. Also, such small equipment generally has a wireless or infrared data communications function and provides the advantage of being able to transfer a taken image to another cell phone, personal computer, or the like on the instant.

When shooting with a small digital camera or cell phone, the camera is liable to move as a release switch is pressed, causing problems such as camera shake which can result in blurring of a taken image. Recently, it has been a common practice for a photographer to take a picture including the photographer, for example, by one-hand operation. This practice is prone to camera shake.

FIG. 1 is a diagram illustrating camera shake.

Broken lines in FIG. 1 indicate positions of a camera 10 when the camera 10 is focused on a subject and solid lines indicate positions of the camera 10 when a photographer presses a release button 11.

Part (A) of FIG. 1 is a top view of the camera 10. When shooting with the camera 10 held in one hand, the front face of the camera 10 may rotate in such a direction (direction of arrow A) as to deviate in the right-and-left direction from the front of the subject. The direction of arrow A corresponds to an azimuth direction with respect to the camera 10 placed horizontally to shoot a horizontally oriented picture, and thus it will be referred to as the azimuth direction hereinafter.

Part (B) of FIG. 1 is a lateral view of the camera 10. In the case of the small camera 10, when pressing the release button 11, the wrist may bend vertically, causing the front face of the camera 10 to rotate in such a direction (direction of arrow B) as to deviate in the up-and-down direction from the front of the subject. Some cell phones have their release button 11 installed on their front face, making them prone to rotation especially in the direction of arrow B. The direction of arrow B corresponds to an elevation direction with respect to the camera 10 placed horizontally to shoot a horizontally oriented picture, and thus it will be referred to as the elevation direction hereinafter.

Part (C) of FIG. 1 is a front view of the camera 10. When shooting with the camera 10 which has its release button 11 installed near its flank, if the camera 10 is held in one hand, it may rotate in a clockwise/counterclockwise direction, as viewed from the subject, when the release button 11 is pressed. The direction of arrow C corresponds to a tumble direction of the camera 10 placed horizontally to shoot a horizontally oriented picture, and thus it will be referred to as the tumble direction hereinafter.

Other than the movements shown in FIG. 1, the camera may make, for example, up-and-down movements, right-and-left movements, back-and-forth movements, or combinations thereof with its front face looking straight ahead at the subject. Although a horizontal movement of the camera looking straight ahead at the subject causes only a small amount of displacement in the image forming position of subject light on an image pickup element, rotational movements in the elevation direction, azimuth direction, and tumble direction cause large amounts of displacement in the image forming position, resulting in blurring of a taken image.

Techniques for preventing camera shake in the rotational directions have been proposed, including a technique for preventing image blur by tilting part of the lenses in a direction normal to an optical axis and thereby decentering it according to movements of the camera (see, for example, Japanese Patent Laid-Open No. 7-301839) and a technique for installing a prism on an optical path and changing its vertical angle according to movements of the camera (see, for example, Japanese Patent Laid-Open Nos. 5-134285, 5-181094, and 8-6087).

However, the camera shake prevention techniques described above cannot correct camera shake in the tumble direction shown in part (C) of FIG. 1 although they can correct camera shake in the elevation direction and azimuth direction shown in parts (A) and (B) of FIG. 1.

### SUMMARY OF THE INVENTION

The present invention has been made in view of the above circumstances and provides a small image pickup apparatus which can reliably prevent camera shake in the tumble direction.

The present invention provides an image pickup apparatus which generates an image signal to represent subject light based on the subject light coming through an image-taking optical system, having:

an image pickup device which generates image signals to represent a subject image formed by the subject light focused on a surface thereof;

a light reflecting mechanism which leads the subject light to the image pickup device as the subject light coming through the image-taking optical system is reflected in sequence by a plurality of reflector sections placed apart from each other;

a rotation sensor which senses rotation of the image pickup apparatus in a place along a surface of the image pickup device; and

a rotating mechanism which reduces displacement of the subject image resulting from the rotation sensed by the rotation sensor, by rotating at least one of the plurality of reflector sections around an axis along an optical path among the plurality of reflector sections.

The image pickup device according to the present invention means a CCD or CMOS sensor containing multiple light-sensitive elements which receive light and generate photoelectric signals.

With the image pickup apparatus according to the present invention, when the rotation sensor senses rotation in the tumble direction, for example, as shown in part (C) of FIG. 1, at least one of the multiple reflector sections is rotated around an axis along an optical path among the multiple reflector sections. Consequently, the subject light is rotated in the opposite direction to the rotation sensed by the rotation sensor and the subject image is formed in the correct direction on the image pickup device. Thus, the image pickup apparatus according to the present invention can reduce blurring of taken images using multiple reflector sections of a conventional image pickup apparatus as they are.

Preferably, the image pickup apparatus according to the present invention has a correction section which corrects the displacement of the subject image which occurs as the optical path leading from the light reflecting mechanism to the image pickup device is displaced in the direction in which the reflector sections are rotated by the rotating mechanism.

When the reflector sections are rotated by the rotating mechanism, the subject image is formed in the correct direction on the image pickup device, but the image forming position is displaced in the same direction as the rotation of the reflector sections. The image pickup apparatus according to a preferred embodiment of the present invention corrects the displacement of the subject image due to the rotation, making it possible to obtain a taken image of higher quality.

The present invention provides a small image pickup apparatus which can reliably prevent camera shake in the tumble direction.

### BRIEF DESCRIPTION OF THE DRAWINGS

FIG. 1 is a diagram illustrating camera shake;

FIG. 2 is an external perspective view of a digital camera according to an embodiment of the present invention, as viewed obliquely from the upper front;

FIG. 3 is a schematic block diagram of the digital camera shown in FIG. 2;

FIG. 4 is a diagram showing two mirrors;

FIG. 5 is a diagram showing a state of the lower mirror when it is rotated, from its position in FIG. 4, around an optical path of light passing between the two mirrors;

FIG. 6 is a diagram showing the lower mirror rotated further from its position in FIG. 5; and

FIG. 7 is a schematic block diagram of components around a CCD in a digital camera according to a second embodiment of the present invention.

### DETAILED DESCRIPTION OF THE INVENTION

Embodiments of the present invention will be described below with reference to the drawings.

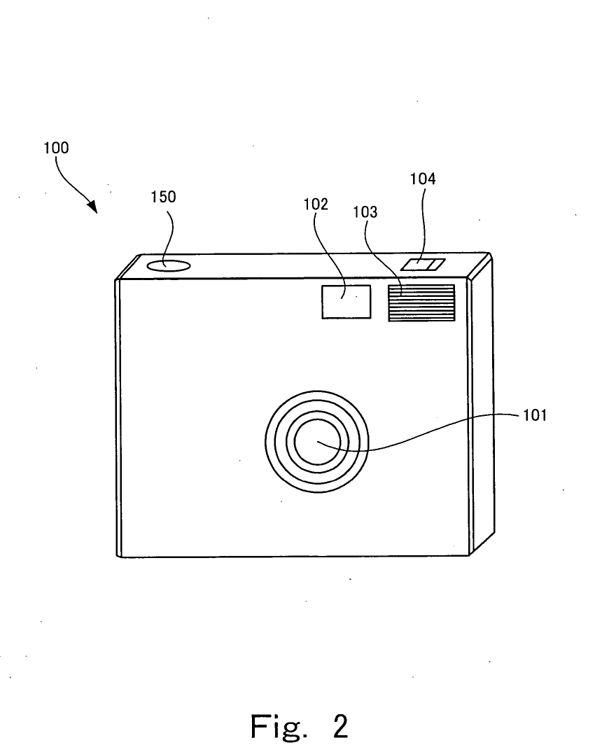

FIG. 2 is an external perspective view of a digital camera according to an embodiment of the present invention. In the following description, a state in which the digital camera 100 is placed horizontally to shoot a horizontally oriented picture as shown in FIG. 2 is assumed to be a normal state. Also, it is assumed that the top side, bottom side, near side, and far side of FIG. 2 correspond to the top, bottom, front, and rear of the digital camera 100, respectively.

At the center in the front face of the digital camera 100, there is a taking lens 101. Also, on an upper front part of the digital camera 100, there are an optical finder's objective window 102 and a fill-flash section 103. Furthermore, on the top face of the digital camera 100, there are a slide-type power switch 104 and a release switch 150.

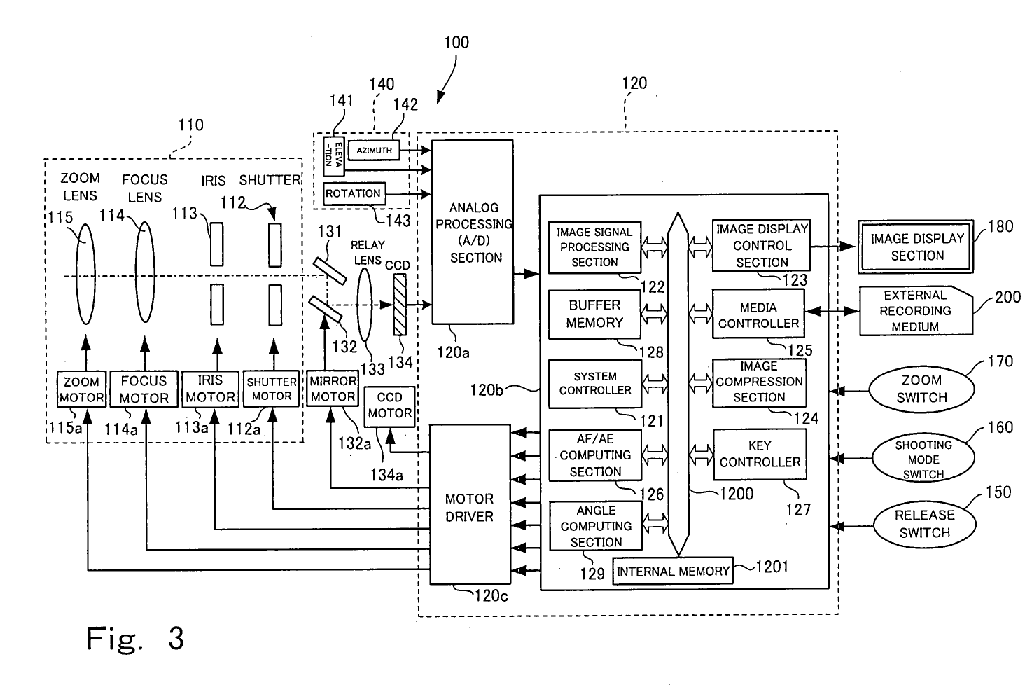

FIG. 3 is a schematic block diagram of the digital camera 100 shown in FIG. 2.

As shown in FIG. 3, the digital camera 100 largely consists of an image-taking optical system 110, various components which lead subject light passing through the image-taking optical system 110 to a CCD 134, and a signal processing section 120. Besides, the digital camera 100 is equipped with an image display section 180 for use to display taken images; an external recording medium 200 for use to record image signals obtained by image taking; a zoom switch 170, a shooting mode switch 160, and the release switch 150 for use to make the digital camera 100 perform various processes for shooting; and movement sensors 140 which sense movements of the digital camera 100.

First, a configuration of the image-taking optical system 110 will be described with reference to FIG. 3.

Subject light enters the digital camera 100 from the left side of FIG. 3 through a zoom lens 115 and focus lens 114 and passes through an iris 113 which adjusts quantity of the subject light. When a shutter 112 is open, the subject light has its optical path bent by mirrors 131 and 132, and then forms an image on the CCD 134 placed behind. Essentially, the image-taking optical system contains multiple lenses, at least one of which plays a major role in focus adjustment while relative positions among the lenses affect focal length. In FIG. 3, the lenses concerned with changing the focal length are schematically shown as the zoom lens 115 while the lenses concerned with the focus adjustment are schematically shown as the focus lens 114.

The zoom lens 115, focus lens 114, iris 113, and shutter 112 are driven by a zoom motor 115a, focus motor 114a, iris motor 113a, and shutter motor 112a, respectively. Instructions to operate the zoom motor 115a, focus motor 114a, iris motor 113a, and shutter motor 112a are transmitted from a digital signal processing section 120b of a signal processing section 120 via a motor driver 120c.

The zoom lens 115 is moved along the optical axis (forward/backward direction) by the zoom motor 115a. As the zoom lens 115 is moved to a position specified by a signal from the signal processing section 120, the focal length is changed and photographic magnification is determined.

The focus lens 114 implements a TTLAF (Through The Lens Auto Focus) function. The TTLAF function moves the focus lens along the optical axis, makes an AF/AE computing section 126 of the signal processing section 120 detect contrast of an image signal obtained by the CCD 134, and moves the focus lens 114 into focus position which corresponds to the lens position that gives a peak contrast. The TTLAF function makes it possible to take a shot by automatically focusing on the subject which gives the peak contrast.

The iris 113 adjusts the quantity of subject light, being driven based on instructions from a system controller 121 of the digital signal processing section 120b.

With the digital camera 100 according to this embodiment, subject light passing through the image-taking optical system 110 is bent by the mirrors 131 and 132 before entering the CCD 134, and thus the optical path of the subject light is longer than the case where the subject light enters the CCD 134 directly from the image-taking optical system 110. This reduces amounts of forward/backward movements of the zoom lens 115 and focus lens 114 needed to implement a zoom function and focus function, resulting in reduced thickness of the digital camera 100.

The above explains the configuration of the image-taking optical system 110.

The CCD 134 and various elements related to it will be described next.

The subject light passing through the image-taking optical system 110 is reflected by the two mirrors 131 and 132 placed one above the other with a clearance between them, passes through a relay lens 133, and forms an image on the CCD 134, which generates image signals representing the subject light. The mirrors 131 and 132 are an example of multiple reflector sections according to the present invention and the CCD 134 is an example of the image pickup device according to the present invention.

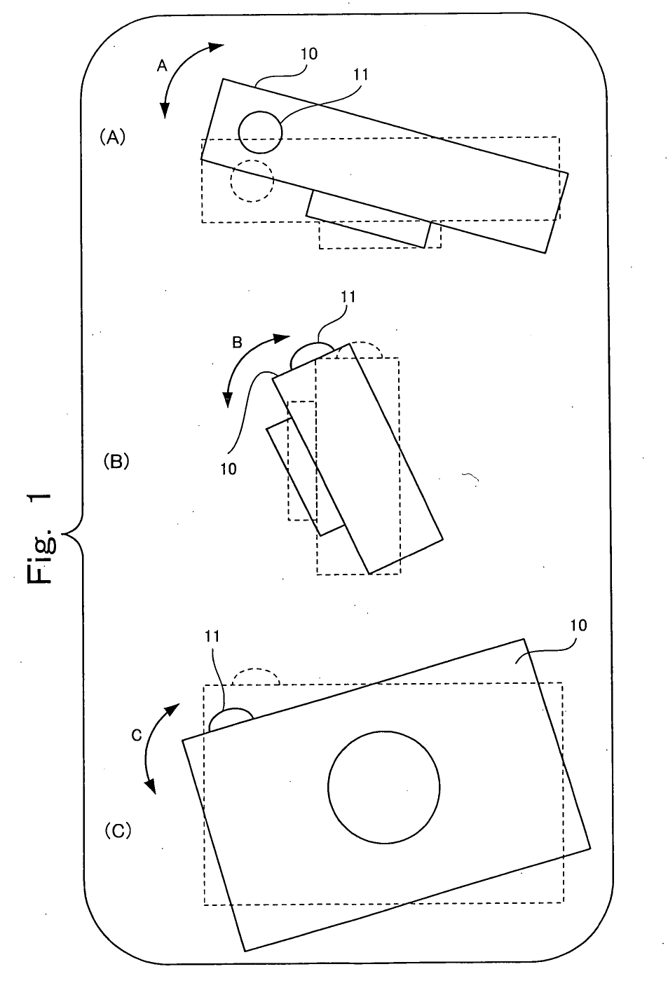

The digital camera 100 is equipped with the movement sensors 140 which sense movements of the digital camera 100. The movement sensors 140 are composed of an elevation velocity sensor 141 which measures angular velocity in the elevation direction (direction of arrow B in FIG. 1) of the digital camera 100, azimuth velocity sensor 142 which measures angular velocity in the azimuth direction (direction of arrow A in FIG. 1) of the digital camera 100, and rotational velocity sensor 143 which measures angular velocity in the tumble direction (direction of arrow C in FIG. 1) of the digital camera 100 around the optical axis. The rotational velocity sensor 143 is an example of the rotation sensor according to the present invention. Measurement results of the elevation velocity sensor 141, azimuth velocity sensor 142, and rotational velocity sensor 143 are converted into digital measurement values by an analog processing (A/D) section 120a and the digital measurement values are transmitted to an angle computing section 129. Upon acquiring the measurement values in the azimuth direction, elevation direction, and tumble direction, the angle computing section 129 calculates the amounts of movement of the lower mirror 132 and CCD 134 based on the measurement values in order to correct the displacement of the subject image on the CCD 134 due to movements of the digital camera 100. The movements of the lower mirror 132 and CCD 134 will be described in detail later. The calculated amounts of movement are transmitted to the motor driver 120c via the system controller 121 and then the motor driver 120c transmits operation commands to a mirror motor 132a and CCD motor 134a. Upon receiving the operation commands from the motor driver 120c, the mirror motor 132a moves the lower mirror 132 according to results of sensing by the movement sensors 140. The CCD motor 134a moves the CCD 134 according to results of sensing by the movement sensors 140. The mirror motor 132a is an example of the rotating mechanism according to the present invention and the CCD motor 134a is an example of the correction section according to the present invention.

Next, a configuration of the signal processing section 120 will be described. The subject image formed on the CCD 134 in the image-taking optical system 110 is read out as image signals by the analog processing (A/D) section 120a, which converts the analog signals into digital signals, which are then supplied to the digital signal processing section 120b. The digital signal processing section 120b is equipped with the system controller 121. Signal processing in the digital signal processing section 120b is performed according to a program which describes operating procedures in the system controller 121. The system controller 121 exchanges data with an image signal processing section 122, image display control section 123, image compression section 124, media controller 125, AF/AE computing section 126, key controller 127, buffer memory 128, and angle computing section 129 via a bus 1200. When data is exchanged via the bus 1200, an internal memory 1201 serves as a buffer. Data which serve as variables are written as needed into the internal memory 1201 according to progress of processes in various parts, and the system controller 121, image signal processing section 122, image display control section 123, image compression section 124, media controller 125, AF/AE computing section 126, key controller 127, and angle computing section 129 perform appropriate processes based on these data. That is, instructions from the system controller 121 are transmitted to the various parts via the bus 1200 to start up the processes in the various parts. The data in the internal memory 1201 are updated according to the progress of the processes and referred to by the system controller 121 to control the various parts. In other words, upon power-up, the processes in the various parts are started according to the procedures of the program in the system controller 121. For example, if the release switch 150, zoom switch 170, or shooting mode switch 160 is manipulated, information about the manipulation is transmitted to the system controller 121 via the key controller 127 and a process corresponding to the manipulation is performed according to the procedures of the program in the system controller 121.

When the shutter is released, the image data read out of the CCD 134 are converted from analog signals into digital signals by the analog processing (A/D) section 120a and the digitized image data are stored temporarily in the buffer memory 128 of the digital signal processing section 120b. RGB signals of the digitized image data are converted by the image signal processing section 122 into YC signals, which are then compressed into an image file in JPEG format by the image compression section 124. The resulting image file is recorded on the external recording medium 200 via the media controller 125. The image data recorded in the image file are played back in the image display section 180 via the image display control section 123. During this process, the AF/AE computing section 126 detects contrast in the RGB signals according to subject distance to adjust focus. Based on the detection results, focus is adjusted by the focus lens 114. The AF/AE computing section extracts luminance signals from the RGB signals and detects field luminance from the luminance signal. Based on the detected field luminance, the iris 113 adjusts exposure so that an appropriate quantity of subject light will fall on the CCD 134.

The digital camera 100 is basically configured as described above.

Movements of the mirror 132 and CCD 134 will be described in detail below.

First, description will be given of a relationship between the rotation of the mirror 132 and subject image formed on the CCD 134.

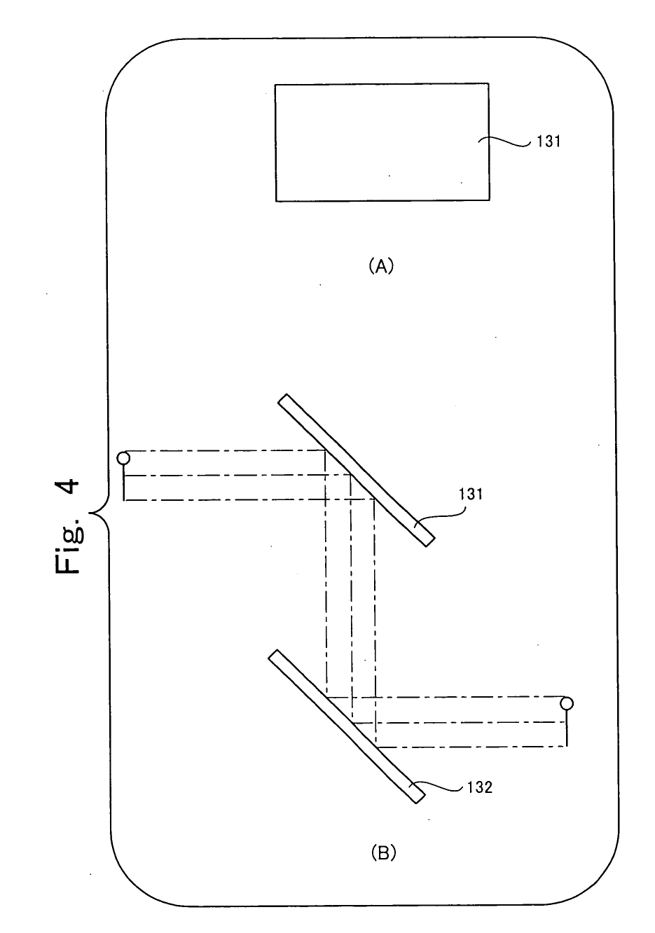

FIG. 4 shows the two mirrors 131 and 132 also shown in FIG. 3.

Part (A) of FIG. 4 is a top view of the mirrors 131 and 132 shown in FIG. 3. Here, the two mirrors 131 and 132 completely overlap vertically.

Part (B) of FIG. 4 is a side view of the mirrors 131 and 132. The two mirrors 131 and 132 are arranged in parallel. Subject light reflected by the mirrors 131 and 132 forms a subject image which points in the same direction as the incident subject light.

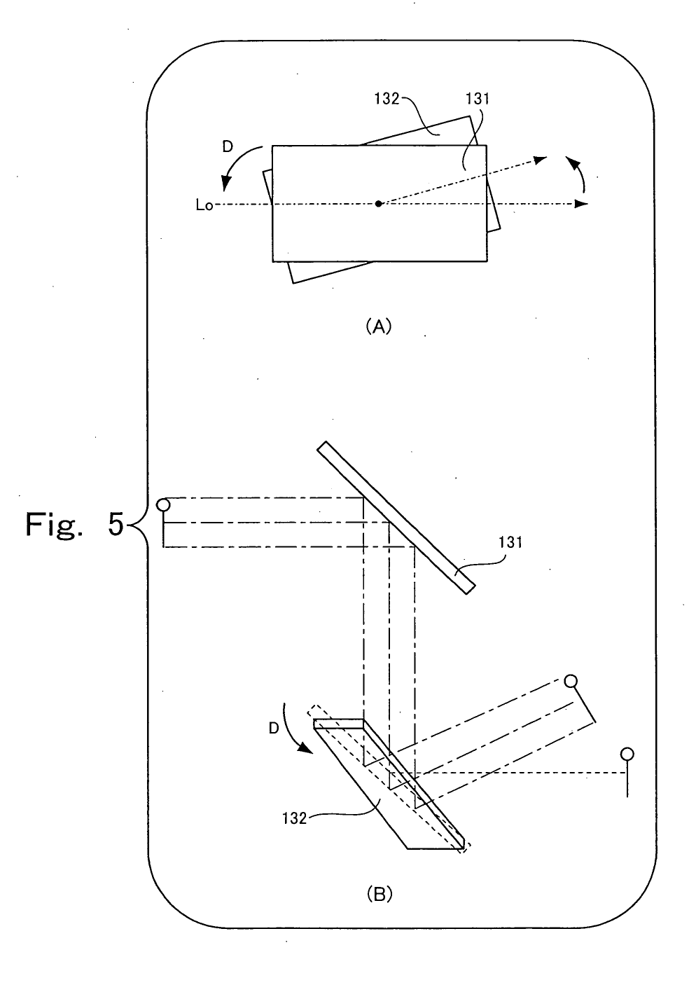

FIG. 5 is a diagram showing a state of the lower mirror 132 when it is rotated, from its position in FIG. 4, around the optical path of light passing between the two mirrors 131 and 132.

As shown in part (A) of FIG. 5, the two mirrors 131 and 132 are displaced with respect to each other as the lower mirror 132 is rotated in the direction of arrow D. When the two mirrors 131 and 132 are arranged in parallel, light L0 incident on the upper mirror 131 from the front is led to the rear by the lower mirror 132. On the other hand, when the mirrors 131 and 132 are displaced with respect to each other, the light L0 incident on the upper mirror 131 is led by the lower mirror 132 to a location displaced from the rear in the direction of arrow D, i.e., in the direction of rotation.

Also, as shown in part (B) of FIG. 5, the subject image formed with the arrangement of the mirrors 131 and 132 shown in FIG. 4, is tilted in the counterclockwise direction as viewed from the incident side of the subject light.

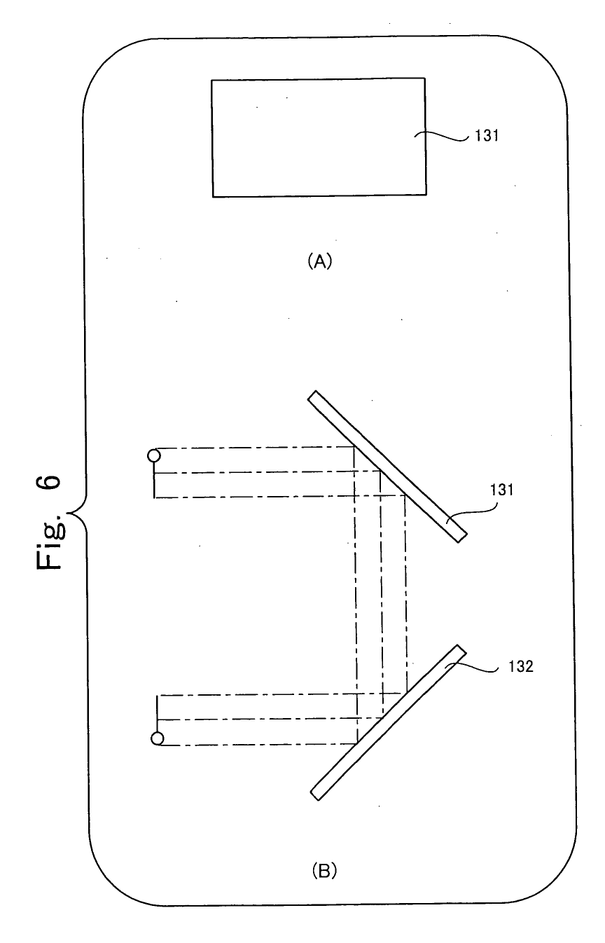

FIG. 6 is a diagram showing the lower mirror 132 rotated further from its position in FIG. 5.

As shown in part (A) of FIG. 6, when the lower mirror 132 is rotated further for a total of 180 degrees from its position in FIG. 4, the two mirrors 131 and 132 completely overlap vertically again. At this time, as shown in part (B) of FIG. 6, the subject light reflected by the two mirrors 131 and 132 is formed on the same side as the subject light, 180 degrees opposite to the side shown in part (B) of FIG. 4. With the arrangement of the mirrors 131 and 132 shown in FIG. 6, the subject light forms an image rotated 180 degrees.

In this way, when the lower mirror 132 is rotated, in the direction of arrow D, around the optical path of the light passing between the two mirrors 131 and 132, the optical path of the subject light rotates in the same direction as the rotation of the mirror 132 and the subject image rotates in the counterclockwise direction as viewed from the incident side of the subject light. Incidentally, in this example, the optical path of the subject light moves in the azimuth direction as the mirror 132 is rotated. The digital camera 100 according to this embodiment prevents camera shake in the tumble direction (direction of arrow C in FIG. 1) of the digital camera 100 using this feature of the mirrors 131 and 132. A method for preventing camera shake of the digital camera 100 will be described below.

As the photographer presses the release button 104 (shown in FIG. 2) with the digital camera 100 directed at the subject; the elevation velocity sensor 141 (shown in FIG. 3) measures the angular velocity in the elevation direction of the digital camera 100, azimuth velocity sensor 142 measures the angular velocity in the azimuth direction of the digital camera 100, and rotational velocity sensor 143 measures the angular velocity in the tumble direction of the digital camera 100. The measurement values are converted into digital values by the analog processing section 120a and transmitted to the angle computing section 129.

The angle computing section 129 calculates the amount of vertical movement of the image in the up-and-down direction of the digital camera 100 based on the angular velocity in the elevation direction, the amount of lateral movement of the image in the right-and-left direction of the digital camera 100 based on the angular velocity in the azimuth direction, and the angle of tumble movement of the image in the tumble direction of the digital camera 100 based on the angular velocity in the tumble direction (direction of arrow C in FIG. 1).

Also, the angle computing section 129 calculates the amount of displacement of the subject image caused by changes in the optical path of the subject light as the lower mirror 132 is rotated around the optical axis of light passing between the two mirrors 131 and 132. In this example, since the optical path of the subject light moves in the azimuth direction as the mirror 132 is rotated, the calculated amount of displacement is added to the amount of lateral movement in the right-and-left direction of the digital camera 100 to calculate a new corrected amount of lateral movement. The calculated values (the amount of vertical movement in the up-and-down direction, corrected amount of lateral movement in the right-and-left direction, and angle of tumble movement in the tumble direction) are transmitted to the motor driver 120c via the system controller 121.

Based on the values transmitted from the angle computing section 129, the motor driver 120c drives the mirror motor 132a and CCD motor 134a. Consequently, the lower mirror 132 is rotated by the angle of the tumble movement around the optical axis of the light passing between the two mirrors 131 and 132 while the CCD 134 is moved by the corrected amount of movement in the right-and-left direction and by the amount of vertical movement in the up-and-down direction.

After the mirror 132 and CCD 134 are moved, the subject image formed on the CCD 134 is read out as image signals by the analog processing section 120a to start an exposure process. At this time, the subject light passing through the image-taking optical system 110 is received at the correct position, reducing displacement of the subject image formed on the CCD 134. Thus, the digital camera 100 according to this embodiment makes it possible to obtain a taken image of higher quality with reduced image blur even if the digital camera 100 moves during shooting.

This concludes description of the first embodiment of the present invention and a second embodiment of the present invention will be described next. The second embodiment has almost the same configuration as the first embodiment except for the components which leads the subject light passing through the image-taking optical system 110 to the CCD 134. Thus, components in common with the first embodiment will be denoted by the same reference numerals as the corresponding components of the first embodiment, omitting description thereof, and only the differences from the first embodiment will be described below.

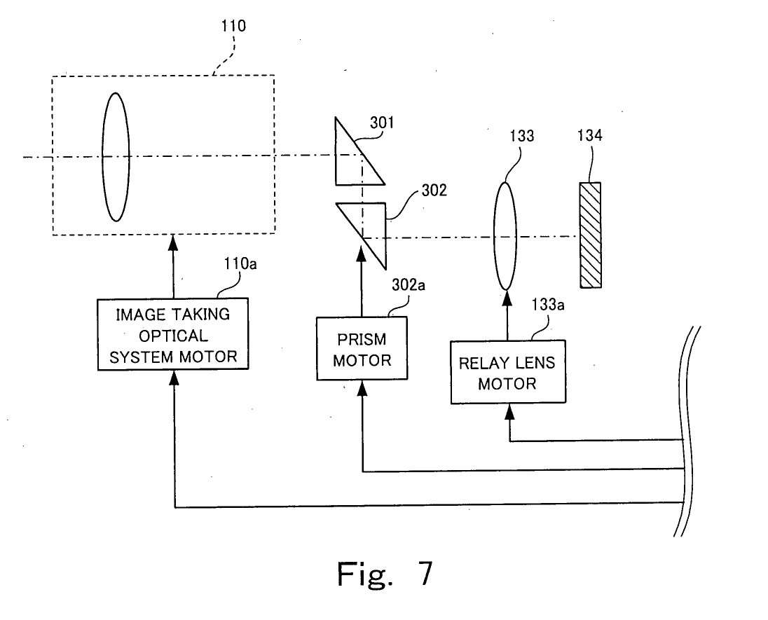

FIG. 7 is a schematic block diagram of components around a CCD in a digital camera according to the second embodiment of the present invention.

Unlike the digital camera 100 according to the first embodiment, the digital camera according to the second embodiment has an image-taking optical system motor 110a which moves the image-taking optical system 110 in the up-and-down direction and right-and-left direction as well as a relay lens motor 133a which moves the relay lens 133 in the up-and-down direction and right-and-left direction. Also, instead of the two mirrors 131 and 132 and mirror motor 132a mounted on the digital camera 100 according to the first embodiment, this embodiment has two prisms 301 and 302 placed one above the other with a clearance between them as well as a prism motor 302a which rotates the lower prism 302 around the optical axis of the light passing between the two prisms 301 and 302.

As in the case of the first embodiment, with the digital camera according to this embodiment, the amount of vertical movement in the up-and-down direction, corrected amount of movement in the right-and-left direction, and angle of tumble movement in the tumble direction are calculated by the angle computing section 129 and the calculated values are transmitted to the motor driver 120c via the system controller 121.

Based on the values transmitted from the angle computing section 129, the motor driver 120c drives the image-taking optical system motor 110a, relay lens motor 133a, and prism motor 302a. Consequently, the image-taking optical system 110 and relay lens 133 are moved by the corrected amount in the right-and-left direction and by the amount of vertical movement in the up-and-down direction while the lower prism 302 is rotated by the angle of tumble movement around the optical axis of the light passing between the two prisms 301 and 302.

In this way, camera shake can also be prevented by using prisms instead of mirrors and moving the image-taking optical system and relay lens instead of the CCD.

Although an example of the velocity sensor which senses the angular velocity in the tumble direction has been described above, the rotation sensor according to the present invention may be an angle sensor which detects the angle of movement in the tumble direction.

Also, a rotating mechanism which moves the lower one of two reflector sections placed one above the other has been described above as an example of the rotating mechanism according to the present invention. However, the rotating mechanism according to the present invention may move all or the top one of multiple reflector sections.

Also, although a correction section which corrects displacement of a subject image by moving the CCD has been described above as an example of the correction section according to the present invention, the correction section according to the present invention may correct displacement of a subject image by image processing.

What is claimed is:

1. An image pickup apparatus which generates image signals to represent subject light based on the subject light coming through an image-taking optical system, comprising:
an image pickup device which generates image signals to represent a subject image formed by the subject light focused on a surface thereof;
a light reflecting mechanism which leads the subject light to the image pickup device as the subject light coming through the image-taking optical system is reflected in sequence by a plurality of reflector sections placed apart from each other;
a rotation sensor which senses rotation of the image pickup apparatus in a place along a surface of the image pickup device; and
a rotating mechanism which reduces displacement of the subject image resulting from the rotation sensed by the rotation sensor, by rotating at least one of the plurality of reflector sections around an axis along an optical path among the plurality of reflector sections.

2. The image pickup apparatus according to claim 1, further comprising a correction section which corrects the displacement of the subject image which occurs as the optical path leading from the light reflecting mechanism to the image pickup device is displaced in the direction in which the reflector sections are rotated by the rotating mechanism.
